(19) United States
(12) Patent Application Publication
(10) Pub. No.: US 2015/0156967 A1
(43) Pub. Date: Jun. 11, 2015

(54) COMPACT HOP HARVESTER

(71) Applicant: Steven Michael Steenland, Roxbury, NY (US)

(72) Inventor: Steven Michael Steenland, Roxbury, NY (US)

(21) Appl. No.: 14/561,465

(22) Filed: Dec. 5, 2014

Related U.S. Application Data
(60) Provisional application No. 61/912,523, filed on Dec. 5, 2013.

(51) Int. Cl. A01D 46/02

(52) U.S. Cl. CPC A01D 46/02

(57) ABSTRACT

The disclosure describes a compact hop harvester machine and method of operation for harvesting hops from small-scale hop yards. Adjustable and flexible fingers in the machine interact to separate hop cones from hop bines as they are conveyed through a cone picking space.

### RELATED APPLICATIONS

This application is a utility application claiming priority from U.S. Provisional Application No. 61/912,523 filed on Dec. 5, 2013.

### FIELD

The invention relates to the field of agricultural equipment for harvesting and processing hops and, more specifically, equipment for removing hop flowers or cones from hop bines harvested from small-scale hop yards.

### BACKGROUND

Hops are a critical ingredient in beer and some other products. “Hops” generally refers to the female flower or hop cone of the hop plant, Humulus lupulus. The hop cone is separated from the leaf covered vine or hop bine of the hop plant and can be added as a fresh ingredient (for example, in fresh hopped beers), dried, pelletized, or otherwise processed for use in beers and other products. Hops have become particularly popular in the United States as craft brewers and craft beer consumers have developed a taste for heavily hopped beers, but hops have been used in beer for centuries as a bittering, flavoring, and preserving (antibacterial) agent. Increasingly, hops are also being used in food preparation, health & beauty, and medical products.

Worldwide production of hops is over 80,000 metric tons per year with the U.S. supplanting Germany as the top hop producing country in 2013. Like many agricultural products, hops come in a large number of varieties. More than 100 varieties are currently used in commercial beer production and include both traditional varieties of hops associated with specific growing regions and beer styles and more recently developed varieties, particularly in the U.S. U.S. beer drinkers may be familiar with hop varieties like Cascade, Amarillo, and Simcoe touted on craft beer labels, as well as famous English (Fuggle, Goldings), German (Spalt, Tettnang), and Czech (Saaz) varieties. Different hop varieties have different growing, maturation, and resistance characteristics that impact where and how they are grown, as well as when and how they are harvested and processed. While hop production in the U.S. is currently dominated by large producers in the Pacific Northwest, there is increasing interest in hop production in other areas of the country, particularly the Northeast, which was the center of U.S. hop production a century ago. Additionally, the growth of the craft, homebrew, and local beer markets has led to increased interest in small-scale cultivation of diverse varieties, with a focus on individual characteristics similar to the notion of terroir in wine.

Hops are generally planted in trellised fields known in the U.S. as hop yards. Rhizomes are planted in hills at the base of the trellis system, which provides lines extending 10-20 feet into the air. Once successfully established, a well-cared-for hop plant may produce hop cones for decades. In most regions, an irrigation system is also provided to ensure sufficient moisture for the plants. During the growing season, hop bines are trained to scale the trellis system and the yard may also require weeding, fertilizing, pest control, and the other tasks associated with raising crops. Harvesting the hop cones is generally done in late summer or early fall and depends on variety, region, and annual growing conditions. Generally, the entire bine is first cut and removed from the trellis system, often using elevated platforms that can be moved through the yard. The hop cones then need to be separated from the gathered hop bines. This can be done by hand, but most commercial hop growers today will seek to automate this process with a hop harvester machine. Once the hop cones are collected, most will be dried to improve their storage and weight characteristics and can be sold as either whole leaf or pelletized and transported to the brewery or other destination. A small portion of hops are now used fresh by craft brewers in seasonal fresh hop beer styles.

Hop harvesters exist in a variety of designs. Industrial hop harvesters are large machines, some larger than 10 feet high, 15 feet long, and 6 feet wide and are typically installed in a barn or other hop processing facility. It is easier to bring the hop bines to the machine than take the machine to the yards. However, there are trailer mounted versions that can be moved to different sites for processing. The best known modern hop harvesters are produced by German agricultural engineering company WOLF Anlagen-Technik GmbH & Co. KG. WOLF harvesters measure throughput in hundreds of bines per hour. Even their smallest machines include seven picking drums with metal picking fingers and handle 120-160 hop bines per hour. These machines have high throughput, but with some loss or damage to hop cones as the bines and separated cones are put through a series of picking drums, separating, and cleaning stages. For a hop grower that only has hundreds of bines and may need to be separated by variety for processing, the use of such a large scale machine is unnecessary and undesirable. Further, these hop harvesters can be prohibitively expensive for small-scale hop operations to acquire and maintain, especially given the very short season (often just a few days) for their use. And due to their size and lack of portability, they may occupy too much of a precious enclosed space like a barn or garage and be too obtrusive into other uses of the space—even during off-season storage. They are also complex and feature-rich, which makes them intimidating and more difficult to maintain for new and small-scale operators. There is a need for a machine that is more efficient than hand picking, but does not have the cost, requirements, or potential for loss of industrial hop machines.

### SUMMARY

### Technical Problem

Harvesting hop cones from hop bines by hand is inefficient, even for small-scale hops producers. Conventional hop harvesting equipment is large, expensive, excessive, and potentially wasteful for small-scale hop growers. A hop harvester for small-scale hop yards is needed that is compact, inexpensive, gentle on the hops being processed, easy to operate, and versatile enough to be customized to the needs of the user and specific crop characteristics to maximize yields.

### Solution to Problem

The present invention is a machine for harvesting hops and a method for harvesting hops using a machine.

In one embodiment, the machine includes a first belt for conveying hop bines having hop cones into a cone picking space. The first belt has a conveying surface and a plurality of conveyor fingers extending substantially perpendicular to the conveying surface for engaging the hop bines. The machine also includes a picking finger carrier substantially parallel to the first belt in the cone picking space. The picking finger carrier has a surface and a plurality of picking fingers extending substantially perpendicular to the surface of the picking finger carrier for engaging hop bines and removing hop cones when hop bines are conveyed through the cone picking space by the first belt. The plurality of conveyor fingers and the plurality of picking fingers are made of flexible materials and arranged on the conveying surface and surface of the picking finger carrier such that they simultaneously and movably engage with the hop bines and hop cones to remove hop cones from the hop bines.

In another embodiment, the machine includes a conveying means for conveying hop bines having hop cones into a cone picking space. The conveying means includes a plurality of conveyor fingers for engaging the hop bines. The machine also includes a picking means for separating hop cones from hop bines in the cone picking space in conjunction with the conveying means. The picking means has a plurality of picking fingers for engaging hop bines and removing hop cones when hop bines are conveyed through the cone picking space by the conveying means. The plurality of conveyor fingers and the plurality of picking fingers are comprised of flexible materials and arranged to simultaneously and movably engage with the hop bines and hop cones to remove hop cones from the hop bines.

In still another embodiment, a machine is used for a method of harvesting hops. The machine receives hop bines via a first belt for conveying hop bines into a cone picking space. The first belt includes a conveying surface and a plurality of conveyor fingers extending substantially perpendicular to the conveying surface for engaging the hop bines. The machine conveys the hop bines into the cone picking space where a picking finger carrier is substantially parallel to the first belt. The picking finger carrier has a surface and a plurality of picking fingers extending substantially perpendicular to the surface of the picking finger carrier for engaging hop bines and removing hop cones when hop bines are conveyed through the cone picking space by the first belt. The machine removes the hop cones from the hop bines using the plurality of conveyor fingers and the plurality of picking fingers, which are made of flexible materials and arranged on the conveying surface and surface of the picking finger carrier such that they simultaneously and movably engage with the hop bines and hop cones to remove hop cones from the hop bines.

### Advantageous Effects of Invention

The present invention provides a hop harvester for small-scale hop yards that is compact, inexpensive, gentle on the hops being processed, easy to operate, and versatile enough to be customized to the needs of the user and specific crop characteristics to maximize yields.

### BRIEF DESCRIPTION OF DRAWINGS

FIG. 1

A diagram showing a front view of the frame of a machine in accordance with the present disclosure.

FIG. 2

A diagram showing a right side view of the frame of a machine (with the picking finger carrier without picking fingers) in accordance with the present disclosure.

FIG. 3

A diagram showing a top view of the picking finger carrier with picking fingers installed in the frame of a machine in accordance with the present disclosure.

FIG. 4

A diagram showing a top view of a picking finger carrier with picking fingers installed in one configuration in accordance with the present disclosure.

FIG. 5

A diagram showing a top view of a picking finger carrier with picking fingers installed in an alternate configuration in accordance with the present disclosure.

FIG. 6

A diagram showing a top view of a picking finger carrier with picking fingers installed in another alternate configuration in accordance with the present disclosure.

FIG. 7

A diagram showing a side cross-section view of a picking finger extending through a portion of a picking finger carrier in accordance with the present disclosure.

FIG. 8

A diagram showing a side view of an example picking finger in accordance with the present disclosure.

FIG. 9

A diagram showing a right side view of an example power system for a machine in accordance with the present disclosure.

FIG. 10

A diagram showing a right side view of an example conveyor system for a machine in accordance with the present disclosure.

FIG. 11

A diagram showing a top view of an example conveyor finger configuration, such as could be used on a conveyer belt system for a machine in accordance with the present disclosure.

FIG. 12

A diagram showing a top view of an alternate example conveyor finger configuration, such as could be used on a conveyer belt system for a machine in accordance with the present disclosure.

FIG. 13

A diagram showing a top view of an example conveyor finger configuration, such as could be used on a sorting belt system for a machine in accordance with the present disclosure.

FIG. 14

A diagram showing a top view of an alternate example conveyor finger configuration, such as could be used on a sorting belt system for a machine in accordance with the present disclosure.

FIG. 15

A diagram showing a partial front cross-sectional view of the upper portion of a machine in accordance with the present disclosure, focused on the picking space.

FIG. 16

A flow chart showing a method of harvesting hops using a machine in accordance with the present disclosure.

FIG. 17

A flow chart showing a method of customizing the operation of a machine in accordance with the present disclosure.

### DESCRIPTION OF EMBODIMENTS

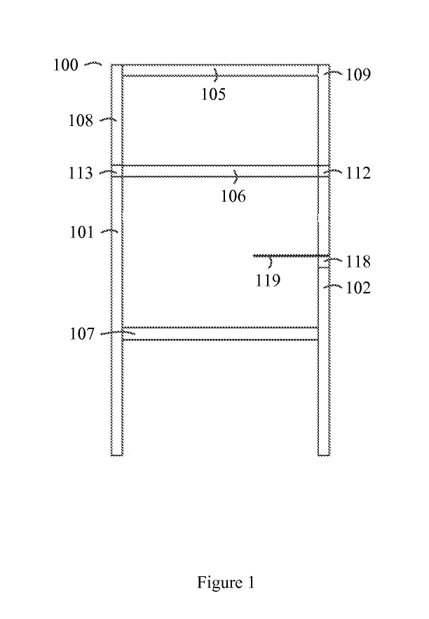

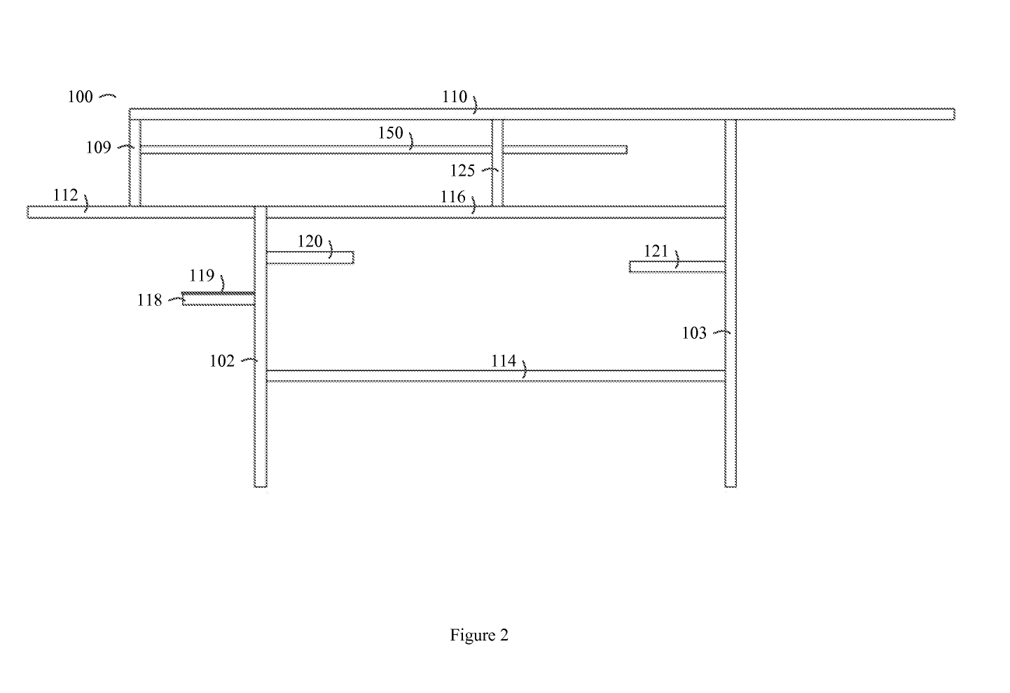

The first example embodiment is a belt-fed compact hop harvester machine for small-scale hop yard use. FIGS. 1 and 2 show the frame 100 of a compact hop harvester machine in accordance with the present disclosure. The frame 100 provides a rigid structure to which various movable components can be attached and may include various adjustment features (not shown). In one embodiment, the frame 100 is constructed from steel members, such as ASTM A500 GR. B steel with a hollow square cross-section 1.5 inches×1.5 inches and 0.125 inches thickness. The frame 100 includes four legs which support the machine. These legs may be freestanding or attached to a floor, platform, or a movable structure, such as a trailer. In the embodiment shown, the frame 100 substantially defines the maximum dimensions of the machine. For example, the frame 100 could be 4½ feet tall, 2½ feet wide, and 9-10 feet long. The rear leg members 103 (left rear leg member not shown) would be 4½ feet tall. The front leg members 101, 102 would be shorter and only extend to the conveyor side support member 116, with the upper portion of the height coming from front vertical support members 108, 109 extending from the conveyor side support members 116 to the top discharge belt support members 110. The cross-members 105, 106, 107, 111 would be under 2½ feet wide (to accommodate the width of the perpendicular members). The top discharge belt support members 110 (left top discharge belt support member not shown) would be 8-9 feet long and the front conveyor support members 112 (left front conveyor support member not shown) would extend 12-16 inches beyond the front end of the top discharge belt support member for a total length of 9-10 feet. Additional side support members are provided for frame integrity, including lower side support members 114 (left lower side support member not shown) and conveyor side support member 116 (left conveyor side support member not shown). In one embodiment, these structural members of the frame 100 are joined by welding, however, fasteners such as bolts, rivets, slots, or adhesives may be employed depending on the materials and specific configuration of the frame. Similarly, one or more members could be made from a single piece and machined, bent, or molded to the desired shapes for the frame.

The purpose of the frame 100 is to provide rigid support for the functional components of the system while maintaining a small footprint. The frame 100 is substantially a box frame on legs. With the example dimensions above it, the box occupies a 2½ feet by 5½ feet footprint. The various extensions from the box are for mounting specific functional components as are various additional members within the box. Alternatively, the frame 100 could be viewed as a lower support box defined by the leg positions and an upper picking box defined by the front vertical support members 108, 109 and rear leg members 103, with forward and rear extensions for supporting the ends of the two conveyor belts. The actual configuration of members is secondary to the function of rigid support of the functional components and, in some embodiments, adjustable attachments for changing the relative positions of those functional components.

In addition to the primary structural members of the frame 100, the additional support members for specific component attachments will now be described. The front conveyor support members 112, 113 mentioned above support one of the rollers for the conveyor belt system. The motor support member 118 supports motor support plate 119 for attaching the motor that drives the belt systems. The transfer sprocket support member 120 provides support for the sprocket system that transfers motion from the motor to the drive rollers for the two conveyor belts. The sprocket system tensioner support member 121 provides support for the tensioner that maintains proper tension in the chain to the drive rollers for the two conveyors. Note that the motor and sprocket systems are only present on the right side of the machine and the related support members are asymmetrical, not present on the left side of the machine. However, an alternative version of the machine could put the motor and sprocket system on the left side or provide symmetrical mounting options for individual users to select based on how the machine will be placed for operation and desired position of the motor and sprocket access. The top discharge belt support members 110 are primary structural members for the frame 100, but also provide an extension beyond the footprint defined by the legs in order to hold the upper roller of the dibble belt for separating hop bines and hop cones. The vertical picking finger carrier support members 125 (right vertical picking finger carrier support member not shown) provide lateral supports for the picking finger carrier 150 (shown in FIG. 2, but not part of the frame 100 in the example embodiment and shown without picking fingers). In one embodiment, the vertical picking finger carrier support members 125 include a plurality of attachment locations and/or a vertically adjustable support means (such as a cuff and resistance bolt) on each member for supporting the picking finger carrier 150 at a variety of heights.

A variety of attachment mechanisms can be used between the frame 100 and the various components attached to it. For example, thru holes, slots, or other features may be formed in the members for accommodating attachment hardware, such as bolts, pins, or rivets. Attachment plates or full or partial cuffs with hardware for mounting the functional components may be welded or otherwise attached to the frame 100 at appropriate locations. In some embodiments, components are permanently affixed to the frame. In others, they are detachably connected such that components can easily be changed or their relative positions adjusted. In still others, a mounting plate or similar surface is permanently attached to the frame 100, but accommodates a detachable or adjustable connector for the components to engage with the mounting plate. The rigid frame provides a simple and versatile support structure for the other machine components.

In addition to the functional components of the machine, the frame 100 also accommodates a number enclosure panels (not shown). Enclosure panels may be added to the machine to better contain the materials being processed, prevent foreign objects from entering the machine, and protect the operator. Enclosure panels may include metal sheeting, metal wire mesh/screen, or other enclosure materials such as fiberglass or polymer sheets, including clear acrylic panels. Alternatively, a plurality of panels can be combined into a housing that fits over portions of the frame 100. In some embodiments, the frame 100 may also facilitate attachment of additional safety features, such as a cage to surround the motor and/or sprockets of the power system to prevent injury.

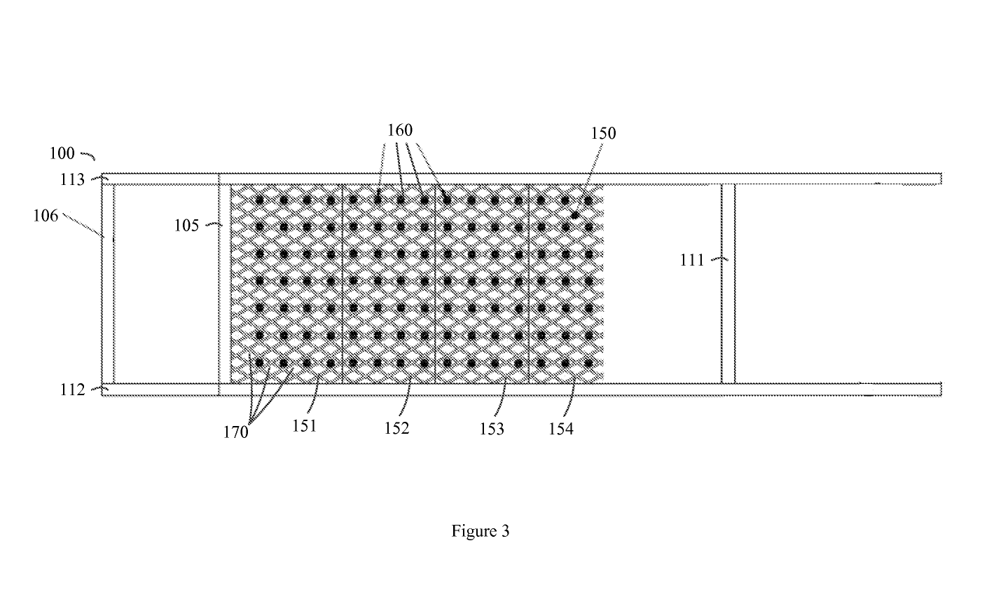

FIG. 3 shows a top view of the picking finger carrier 150 situated in the frame 100 with picking fingers 160 installed. In the example embodiment, the picking finger carrier 150 is not permanently attached to the frame 100, but is removably connected such that it maintains its position during operation, but can be removed for cleaning and reconfiguring the picking fingers 160. Removable connection may include frictional compression if the picking finger carrier 150 against the frame 100 or a variety of latches, bolts, notches, or similar attachment mechanisms, with a desire to maintain the position during use while allowing convenient removal when desired.

In the example shown, the picking finger carrier 150 is made of a wire mesh that defines a matrix of openings 170 that can each accommodate one of the picking fingers 160. The picking finger carrier 150 includes a large number of openings 170 that each represents a potential picking finger position. Without sectioning the picking finger carrier, the matrix of picking finger positions includes 27 rows with 19 available positions in each row, for 513 potential picking finger locations. However, some spaces are required to accommodate the conveyor fingers (not shown) and hop bines themselves, so it is unlikely that a picking finger would be placed in each picking finger location. Other configurations of the picking finger carrier 150 could include more or fewer picking finger positions and may include more selective positions, rather than a continuous matrix of positions. For example, the available positions could exclude the direct path of the conveyor fingers (in a machine with fixed rather than adjustable conveyor fingers). The example shown includes installation of 105 picking fingers 160 in an evenly spaced 7×15 grid, with approximately 2 inch spacing between adjacent picking fingers. Also note that the width of the picking finger carrier generally defines the width of the picking space in the machine (and is usually substantially matched to the conveyor belt width) and the length of the picking finger carrier generally defines the path length through the picking space in the machine. For a compact hop harvester, the width of the picking space is generally between 18-48 inches and the path length of the picking space is generally between 30-72 inches.

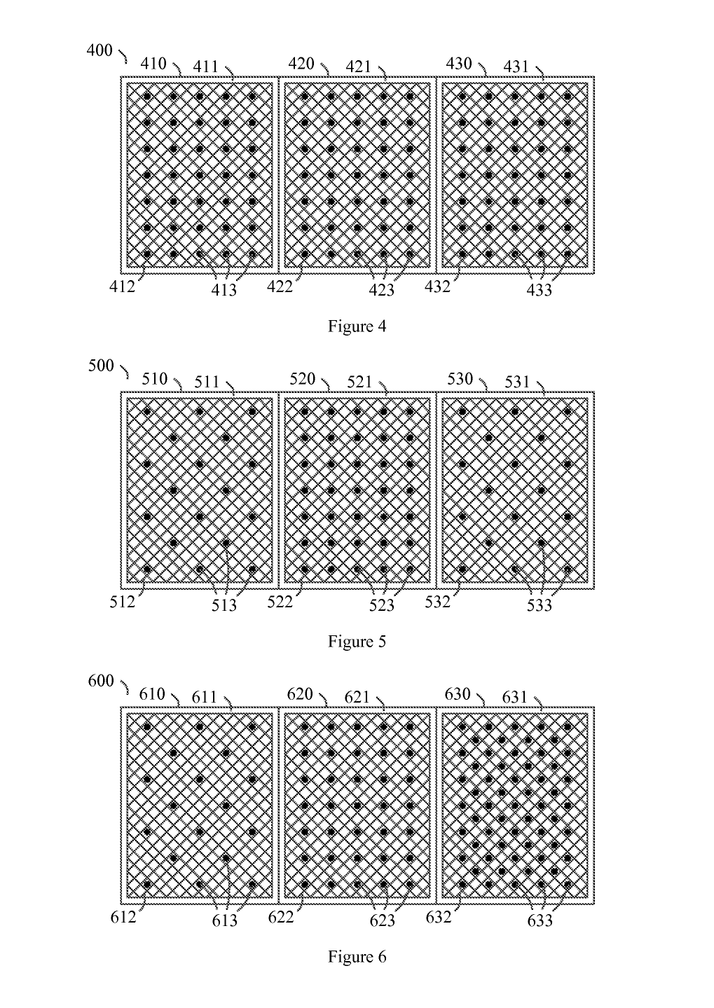

In the example, the picking finger carrier 150 is divided into sections 151, 152, 153, 154 that may be more manageably removed and handled. The picking finger carrier sections 151, 152, 153, 154 may be made simply by cutting the metal mesh of the picking finger carrier 150 across its width for the desired number of sections. Some picking finger positions may be lost at the seams between the sections which will no longer have the integrity to hold a picking finger in place. To further improve handling, each of the sections may also be set inside a separate section frame (see FIGS. 4-6). In one embodiment, different attachment means may be used for the different sections, based on the frequency with which they are removed or other considerations. For example, sections 151 and 154 may be easily reached from the ends of the machine and may not need to be removed as often. In one embodiment (not shown), section 151 is angled up towards the front of the machine where the hope bines are fed into the machine, rather than being coplanar with the other sections (as shown in FIG. 2). The angled portion improves the ease of feeding hob bines into the machine, but the angled position may require a different attachment mechanism, such as being bolted to mounting plates or even welded in place.

The example is designed for easy customization of the picking finger configuration in the picking finger carrier. FIGS. 4, 5, and 6 show three picking finger carriers 400, 500, 600 with different picking finger configurations. Picking finger carrier 400 includes three carrier sections 410, 420, 430 that could be separately removable from the machine. The three carrier sections 410, 420, 430 each have a carrier frame 411, 421, 431 and a matrix of picking finger positions 412, 422, 432. The three carrier sections 410, 420, 430 each have a plurality of picking fingers 413, 423, 433. In picking finger carrier 400, each of the three carrier sections 410, 420, 430 have the same medium density configuration of picking fingers. Picking finger carrier 500 includes three carrier sections 510, 520, 530 that could be separately removable from the machine. The three carrier sections 510, 520, 530 each have a carrier frame 511, 521, 531 and a matrix of picking finger positions 512, 522, 532. The three carrier sections 510, 520, 530 each have a plurality of picking fingers 513, 523, 533. In picking finger carrier 500, only central carrier section 520 has the medium density configuration of picking fingers. The other carrier sections 510, 530 have lower density configuration of picking fingers. Picking finger carrier 600 includes three carrier sections 610, 620, 630 that could be separately removable from the machine. The three carrier sections 610, 620, 630 each have a carrier frame 611, 621, 631 and a matrix of picking finger positions 612, 622, 632. The three carrier sections 610, 620, 630 each have a plurality of picking fingers 613, 623, 633. In picking finger carrier 600, each of the three carrier sections 610, 620, 630 have a different configuration of picking fingers. The first carrier section 610 has a lower density configuration. The central carrier section 620 has a medium density configuration. The final carrier section 630 has a higher density configuration. While the variations in picking finger configurations shown include evenly spaced matrix of picking fingers in varying densities, many other configurations are possible. They do not need to be evenly spaced across the carrier and could be provided in any pattern that provides the desired interaction with the conveyor fingers and hop bines.

In an alternate design, a plurality of picking finger carriers with different picking finger configurations could be provided with the machine, allowing users to maintain a number of configurations and easily swap them in and out during machine operation, without having to reconfigure individual fingers. This would be particularly useful with a plurality of removable sections, such as the sectioned picking finger carriers 400, 500, 600 in FIGS. 4, 5, and 6.

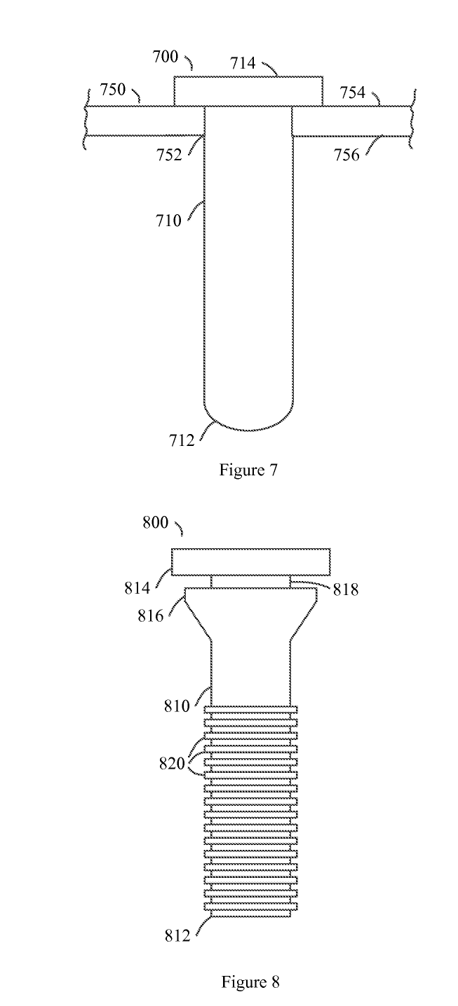

FIG. 7 shows a close up cross-section view of a picking finger 700 extending through a picking finger carrier 750. The picking finger 700 includes a cylindrical body 710 with a distal end 712. The picking finger 700 also includes a flanged end 714 opposite the distal end 712. The cylindrical body 710 is made of a flexible material such that it will deflect when resistance is provided by conveyor fingers or hop bines moving against during operation of the machine. In the example embodiment, the picking finger 700 is made of a single piece of durable yet flexible rubber. The picking finger carrier 750 includes an opening 752 through which the picking finger 700 extends. The opening 752 has an internal restriction dimension that is substantially similar to the diameter of the picking finger 700 and provides frictional retention of the cylindrical body 710 in the opening 752. The picking finger carrier 750 includes an upper surface 754 that engages in flanged end 714 to prevent the picking finger carrier from being pushed completely through the picking finger carrier. The picking finger carrier 750 includes a lower surface 756 through which the cylindrical body 710 extends substantially perpendicular to the lower surface 756. The picking finger 700 is a very basic finger design. Additional picking finger design features can be incorporated to improve installation and retention in the picking finger carrier as well as flexion and separation action when removing hop cones from hop bines in operation.

FIG. 8 shows a side view of a more complex picking finger 800. The picking finger 800 includes a cylindrical body 810, distal end 812, and flanged end 814, but also incorporates additional features. The flanged end 814 and a retention collar 816 define a retention channel 818 into which the picking finger carrier (not shown) could be seated to minimize vertical movement during operation. The retention collar 816 has a smaller diameter than the flanged end 814 so that it can be inserted through an opening in the picking finger carrier (with some compression of the collar), but has a diameter greater than the cylindrical body 810 and the opening in the picking finger carrier to improve retention once seated. The retention collar 816 tapers down to join the cylindrical body 810 for ease of installation. The picking finger 800 also includes a plurality of gripping flanges 820 designed to increase the surface flexibility and engagement with the hop bines for hop cone removal. Other forms of surface treatment and/or texturing could be provided for desired hop cone picking or separation characteristics.

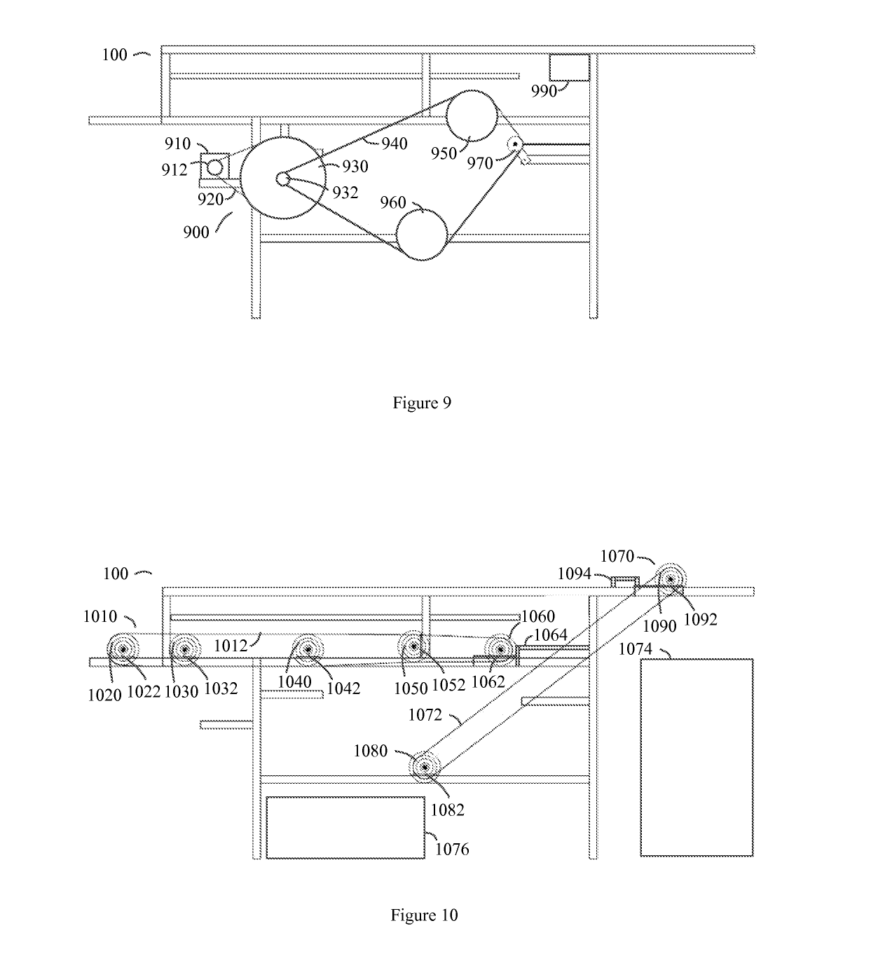

FIG. 9 shows a side view of the frame 100 with the power system 900 installed. The purpose of the power system is to consistently control the relative speeds of the conveyor belts in the machine. In the example, the power system 900 draws its power from a small motor 910, such as a 1 horsepower 1750 rpm 110 volt electric motor that can be plugged into a conventional wall outlet (such as are available in many barns and garages). The motor 910 is mounted to the motor base plate of the frame 100. Alternate designs could incorporate other power systems, such as a tractor power take off, compressor, or generator system. In an alternate embodiment, a variable speed electric motor is used to enable the operator to precisely control the belt speeds with multiple motor speeds or a continuously variable speed motor. The motor 910 turns a drive shaft and sprocket 912, such as a 10 tooth 1.84 inch diameter sprocket. The motion of the motor sprocket 912 moves motor chain 920 to turn the control sprocket assembly via a large sprocket 930, such as a 96 tooth 14.57 inch diameter sprocket, with is mounted on a common shaft with a small sprocket 932, such as another 10 tooth 1.84 inch diameter sprocket, to regulate the speed and torque of the conveyor drive chain 940. The control sprocket assembly is mounted to a support member extending from frame 100. The conveyor drive chain 940 in turn drives the picking belt sprocket 950 and the sorting belt sprocket 960, both of which could be 60 tooth 9.84 inch diameter sprockets, which are connected to the belt system described with regard to FIG. 10. The conveyor drive chain 940 also passes through an adjustable tensioner sprocket 970. The purpose of a tensioner to maintain optimal chain tension throughout the life of the machine and to enable release of the chain when needed will be readily understood. In the example, a tensioner spring and turnbuckle assembly provide the tension to the tensioner sprocket 970, which is supported on an arm mounted to the frame 100. Selection of sprocket sizes and ratios can be used to adjust the relative speeds of the two belts and their relationship to the speed of the drive motor. Alternate configurations of sprockets and chains or even separate power systems for the two belts are possible. Belt speed may be tuned to a particular configuration of fingers and spacings between the conveyor fingers and the picking fingers. For example, a slower speed may be appropriate for a higher density configuration of picking fingers. A variable speed motor enables adjustment of the motor and belt speeds during operation or when changing picking finger configurations. Additional power devices may also be added to the machine, such as the blower fan 990 (which uses a separate power source in the example), which is positioned above the sorting conveyor belt to assist in sorting the separated hop cones from the hop bines.

FIG. 10 shows a right side view the conveyor belt system of the example machine. The conveyor system is mounted to the frame 100 and includes two separate belts, conveyor belt system 1010 and sorting belt system 1070. Conveyor belt system 1010 receives hop bines from the front of the machine and pulls them through the picking space and onto sorting belt system 1070. Sorting belt system 1070 is an inclined dribble belt with conveyor fingers to guide hop bines up the sorting belt system 1070 to be discharged into a hop bine collection area 1074, while separated hop cones roll down the sorting belt system 1070 to be discharged into the hop cone collection area 1076. Conveyor belt system 1010 includes a conveyor belt 1012 with a surface onto which conveyor fingers (not show in FIG. 10) can be installed to assist with conveying hob bines through the machine. The conveyor belt 1012 is supported by a plurality of rollers 1020, 1030, 1040, 1050, 1060, which are each supported by a pair of mounting brackets 1022, 1032, 1042, 1052, 1062 (only the right mounting brackets are shown of each pair) attached to the frame 100. The power system 900 drives at least one of the rollers 1020, 1030, 1040, 1050, 1060. In the example, the roller 1060 nearest the sorting belt system 1070 is connected to a sprocket of the power system to drive the conveyor belt system 1010. The conveyor belt system 1010 may also be equipped with a slide tensioner 1064 for adjusting the tension in conveyor belt 1012 by moving the attached roller 1060. The sorting belt system 1070 includes a dribble belt 1072 that both conveys hop bines in the direction of belt movement and allows hop cones to dribble down the belt under the force of gravity. The dribble belt has a surface onto which conveyor fingers (not shown in FIG. 10) can be installed to assist with conveying hop bines into the hop bine discharge area 1074. The dribble belt 1072 is supported by a pair of rollers 1080, 1090, which are each supported by a pair of mounting brackets 1082, 1092 (only the right mounting brackets are shown of each pair) attached to the frame 100. The power system 900 drives at least one of the rollers 1080, 1090. In the example, the bottom roller 1080 is connected to a sprocket of the power system to drive the sorting belt system 1070. The sorting belt system 1070 may also be equipped with a slide tensioner 1094 for adjusting the tension in dribble belt 1072 by moving the attached roller 1090. Alternative designs for conveying hop bines through the picking space or sorting the hop bines from the hop cones are possible and the exact configuration of the belt systems is provided as an example only.

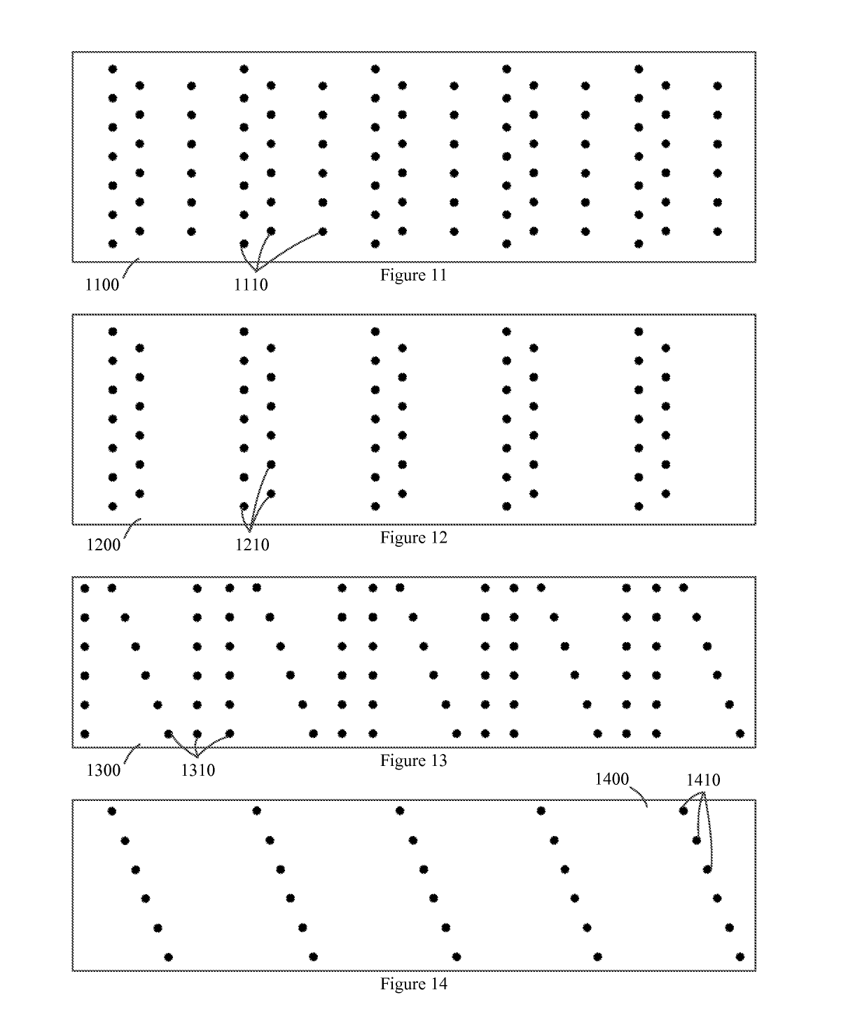

FIGS. 11 and 12 show two alternatives for configuring the conveyor fingers on the conveyor belt of a conveyor belt system like conveyor belt system 1010 in FIG. 10. Conveyor belt 1100 provides a surface for mounting a plurality of conveyor fingers 1110 in a desired configuration. Conveyor belt 1200 also provides a surface for mounting a plurality of conveyor fingers 1210 in an alternate configuration. These configurations are provided as examples only and to demonstrate that there are a variety of configurations that could be used for conveying hop bines through the picking space of the example machine.

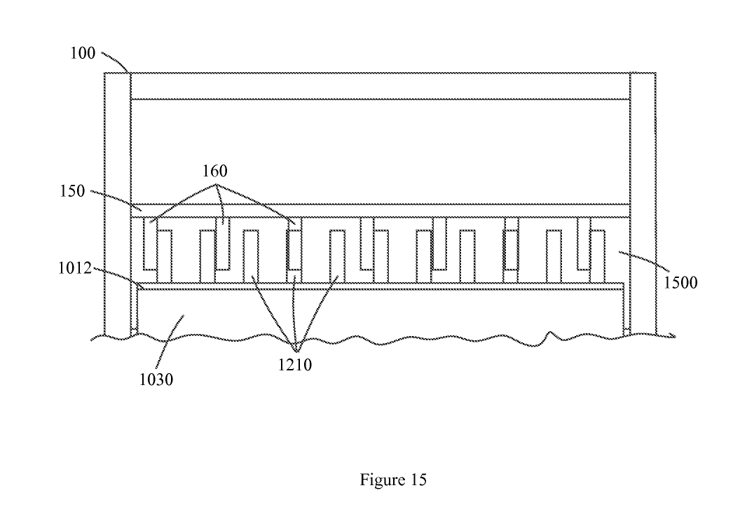

FIGS. 13 and 14 show two alternatives for configuring the conveyor fingers on the dribble belt of a sorting belt system like sorting belt system 1070 in FIG. 10. Dribble belt 1300 provides a surface for mounting a plurality of conveyor fingers 1310 in a desired configuration. Conveyor belt 1400 also provides a surface for mounting a plurality of conveyor fingers 1410 in an alternate configuration. These configurations are provided as examples only and to demonstrate that there are a variety of configurations that could be used for conveying hop bines through the picking space of the example machine.

FIG. 15 shows the interaction between the conveyor fingers and the picking fingers in the picking space 1500. FIG. 15 is a partial cross-sectional view of the upper portion of the example machine where the frame 100 supports the picking finger carrier 150 and the conveyor belt 1012 on roller 1030. Picking fingers 160 extend downward substantially perpendicular to the bottom surface of the picking finger carrier 150. Conveyor fingers 1210 extend upward substantially perpendicular to the upper surface of the conveyor belt 1012. The distance between the bottom surface of the picking finger carrier 150 and the upper surface of the conveyor belt 1012 define the vertical dimension of the picking space 1500. The picking fingers 160 and the conveyor fingers 1210 each have a height that they protrude from their respective surfaces. The sum of these heights is less than the vertical dimension of the picking space 1500 such that picking fingers 160 will interact with the conveyor fingers 1210 as the moving conveyor fingers 1210 and hop bines move through the stationary picking fingers 160. The picking finger carrier 150 and the upper surface of the conveyor belt 1012 are substantially parallel and the direction of motion of the conveyor belt 1012 through the picking space is also parallel to the picking finger carrier 150, which maintains a stationary position during operation. This causes conveyor fingers 1210 that align laterally with some portion of a picking finger 160 (shown as overlapping outlines in FIG. 15) to collide with one another. Because the picking fingers 160 and conveyor fingers 1210 are made of flexible materials, they will deflect around one another, as well as around hop bines passing through the picking space 1500, creating scraping and pinching interactions intended to separate the hop cones from the hop bines. These simultaneous interactions of the picking fingers and conveyor fingers with the hop bines create the picking action in the picking space 1500. The relative configurations of the picking fingers and conveyor fingers will impact the frequency and force of these interactions, as will the size of the picking fingers and conveyor fingers (both diameter and height), the height of the picking space 1500, and the speed of the belt. Operators who are familiar with the characteristics of a given hop crop to be harvested, including variety, size, ripeness, moisture content, and other factors impacting the relative size and integrity of the hop bines, hop cones, and the stems attaching them, can vary the configurations and speed to optimize the picking action.

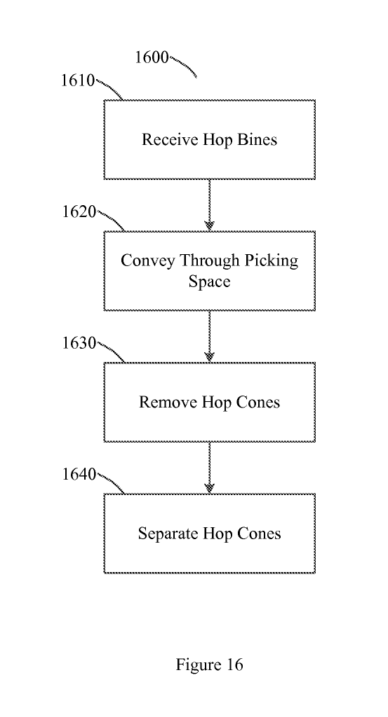

FIG. 16 shows a method 1600 of harvesting hops using a machine as described above with regard to the example compact hop harvester. In step 1610, hop bines are received by the machine through a front feeding area whereby the conveyor fingers engage the hop bines and pull them toward the picking space. In step 1620, the hop bines are conveyed through the picking space where the picking fingers and conveyor fingers will simultaneously interact with the hop bines. In step 1630, hop cones are removed from the hop bines by the pinching and scraping action of the picking fingers and conveyor fingers as they deflect around one another and the hop bines and hop cones. In step 1640, the flow of detached hop cones and hop bines is separated. Using a dribble belt, the hop cones can be allowed to flow into a hop cone collection area and the hop bines can be directed to a hop bine discharge area.

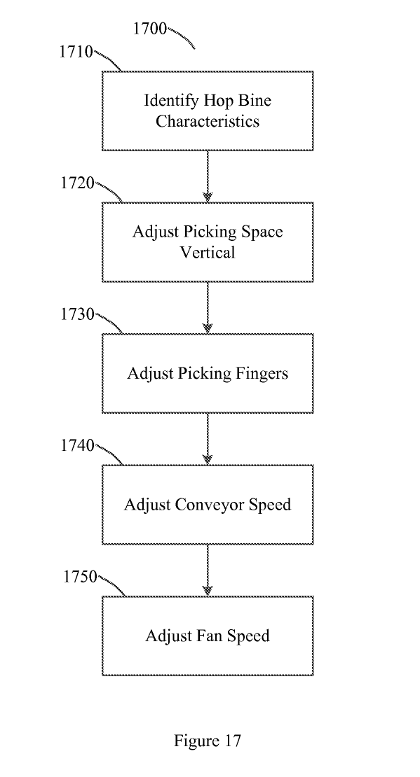

FIG. 17 shows a method 1700 of customizing the operation of a hop harvesting machine to suit the characteristics of a particular hop crop. In step 1710, the operator identifies hop bine characteristics relevant to the setup of the hop harvesting machine, such as variety, size, ripeness, moisture content, and other factors impacting the relative size and integrity of the hop bines, hop cones, and the stems attaching them. In step 1720, the operator adjusts the vertical picking space using an adjustable positioning attachment between the frame of the machine and the picking finger carrier. This step requires an adjustment feature that may not be present in all machines. In step 1730, the operator adjusts the configuration of the picking fingers, such as my adding or removing picking fingers inserted in picking finger positions in the picking finger carrier. In some embodiments, the operator may be able to remove the picking finger carrier or sections thereof to make reconfiguring the picking fingers easier or may even have multiple, preconfigured picking finger carriers or picking finger carrier sections that can be swapped without moving individual fingers. In some embodiments, there may also be an option to vary the positions of the conveyor fingers. In step 1740, the operator adjusts the conveyor speed based upon the hop bine characteristics and the selected configuration of picking fingers. Alternatively, the operator may adjust the speed during operation as appropriate to feedback on the picking performance. This step requires a variable speed power system that may not be present on all machines. In step 1750, the blower fan for the dribble belt may be turned off, on, or its speed adjusted (if it is a variable speed fan). This adjustment may be made based upon appropriate feedback on the separating performance. This step requires a blower fan that may not be present on all machines. These adjustments to the configuration of the machine may not be made in the order stated and may be made iteratively as appropriate to the continuous performance, as well as between batches of hops being processed.

1. A machine for harvesting hops, comprising:
a first belt for conveying hop bines having hop cones into a cone picking space, the first belt including a conveying surface and a plurality of conveyor fingers extending substantially perpendicular to the conveying surface for engaging the hop bines;
a picking finger carrier substantially parallel to the first belt in the cone picking space, the picking finger carrier having a surface and a plurality of picking fingers extending substantially perpendicular to the surface of the picking finger carrier for engaging hop bines and removing hop cones when hop bines are conveyed through the cone picking space by the first belt; and
wherein the plurality of conveyor fingers and the plurality of picking fingers are comprised of flexible materials and arranged on the conveying surface and surface of the picking finger carrier such that the plurality of conveyor fingers and the plurality of picking fingers simultaneously and movably engage with the hop bines and hop cones to remove hop cones from the hop bines.

2. The machine of claim 1, wherein the first belt is comprised of a belt material that defines a plurality of conveyor finger positions on the conveying surface to which the plurality of conveyor fingers may be detachably connected and wherein the plurality of conveyor finger positions is greater than the plurality of conveyor fingers to enable selective positioning of the plurality of conveyor fingers.

3. The machine of claim 1, wherein the picking finger carrier is comprised of a carrier material that defines a plurality of picking finger positions on the surface of the picking finger carrier to which the plurality of picking fingers may be detachably connected and wherein the plurality of picking finger positions is greater than the plurality of picking fingers to enable selective positioning of the plurality of picking fingers.

4. The machine of claim 3, wherein the plurality of picking fingers each comprise a flexible cylinder detachably connected to the picking finger carrier at a picking finger position selected from among the plurality of picking finger positions.

5. The machine of claim 4, wherein the picking finger position defines an opening with an internal restriction dimension and the flexible cylinder has a distal end and a flanged end whereby the distal end is inserted through the opening at the picking finger position and the flanged end includes a maximum dimension that exceeds the internal restriction dimension and whereby the flanged end engages the picking finger carrier and retains the picking finger in the picking finger position during operation of the machine.

6. The machine of claim 1, wherein the picking finger carrier is detachably connected to machine frame for maintaining relative positions of the picking finger carrier and the first belt during operation of the machine and whereby the picking finger carrier may be removed from the machine for repositioning of the plurality of picking fingers.

7. The machine of claim 1, wherein the first belt and the picking finger carrier each have a substantially similar width defining a lateral dimension of the cone picking space and wherein the lateral dimension of the cone picking space is between 18 inches and 48 inches.

8. The machine of claim 1, wherein the conveying surface and the surface of the picking finger carrier have a minimum vertical spacing between them defining a vertical dimension of the cone picking space and wherein the vertical dimension of the cone picking space is between 4 inches and 12 inches.

9. The machine of claim 8, wherein the first belt and the picking finger carrier are both mounted to a machine frame for maintaining their relative positions and further comprising an adjustable mounting for changing the vertical dimension of the cone picking space based upon a desired vertical dimension for the hop bines being processed.

10. The machine of claim 1, wherein the picking finger carrier has a length from at least one picking finger start position to at least one picking finger end position along a direction of conveyor motion of the first belt defining a path length of the cone picking space and wherein the path length of the cone picking space is between 30 inches and 72 inches.

11. The machine of claim 1, wherein the first belt is powered by a motor and wherein the motor has a plurality of speed setting whereby a conveyor speed of the first belt is selectively adjusted based upon a desired conveyor speed for the hop bines being processed.

12. The machine of claim 1, further comprising a second belt positioned below a discharge end of the first belt and angled such that separated hop cones travel against a direction of conveyor motion of the second belt and into a hop cone collection area while hop bines travel with the direction of conveyor motion of the second belt to a hop bine discharge area.

13. The machine of claim 12, further comprising at least one fan positioned to direct air adjacent the second belt, whereby air movement assists in separating hop cones from hop bines.

14. A machine for harvesting hops, comprising:
a conveying means for conveying hop bines having hop cones into a cone picking space, the conveying means including a plurality of conveyor fingers for engaging the hop bines;
a picking means for separating hop cones from hop bines in the cone picking space in conjunction with the conveying means, the picking means having a plurality of picking fingers for engaging hop bines and removing hop cones when hop bines are conveyed through the cone picking space by the conveying means; and
wherein the plurality of conveyor fingers and the plurality of picking fingers are comprised of flexible materials and arranged to simultaneously and movably engage with the hop bines and hop cones to remove hop cones from the hop bines.

15. The machine of claim 14, wherein the plurality of picking fingers each comprise a flexible member detachably connected to a picking finger carrier at a picking finger position selected from among a plurality of picking finger positions.

16. The machine of claim 14, wherein the conveying means and the picking means are maintained in spaced relative positions defining a vertical dimension of the cone picking space and further comprising an adjustment means for changing the vertical dimension of the cone picking space based upon a desired vertical dimension for the hop bines being processed.

17. The machine of claim 14, further comprising a sorting means whereby separated hop cones are discharged into a hop cone collection area while hop bines are discharged into a hop bine discharge area that is separate from the hop cone collection area.

18. A method of harvesting hops by a machine, comprising:
receiving hop bines in the machine via a first belt for conveying hop bines having hop cones into a cone picking space, the first belt including a conveying surface and a plurality of conveyor fingers extending substantially perpendicular to the conveying surface for engaging the hop bines;
conveying the hop bines into the cone picking space of the machine where a picking finger carrier is substantially parallel to the first belt in the cone picking space, the picking finger carrier having a surface and a plurality of picking fingers extending substantially perpendicular to the surface of the picking finger carrier for engaging hop bines and removing hop cones when hop bines are conveyed through the cone picking space by the first belt; and
removing the hop cones from the hop bines using the plurality of conveyor fingers and the plurality of picking fingers comprised of flexible materials and arranged on the conveying surface and surface of the picking finger carrier such that the plurality of conveyor fingers and the plurality of picking fingers simultaneously and movably engage with the hop bines and hop cones to remove hop cones from the hop bines.

19. The method of claim 18, wherein the plurality of picking fingers are detachably connected to the picking finger carrier and may be arranged in a plurality of picking finger positions on the surface of the picking finger carrier and further comprising the step of selectively positioning the plurality of picking fingers in the plurality of picking finger positions based upon characteristics of the hop bines and hop cones being received by the machine.

20. The method of claim 18, wherein the first belt and the picking finger carrier are both mounted to a machine frame with an adjustable mounting for maintaining their relative positions and further comprising the step of changing a vertical dimension of the cone picking space based upon a desired vertical dimension for the hop bines being processed.

21. The method of claim 18, further comprising the step of sorting hop cones from hop bines whereby separated hop cones are discharged into a hop cone collection area while hop bines are discharged into a hop bine discharge area that is separate from the hop cone collection area.
